(19) United States
(12) Patent Application Publication
(10) Pub. No.: US 2026/0197519 A1
(43) Pub. Date: Jul. 9, 2026

(54) PROBABILISTIC TRUE COLOR ESTIMATE FOR REAL-TIME CAMERA APPLICATIONS

(71) Applicant: Lenovo (United States) Inc., Morrisville, NC (US)

(72) Inventors: Rafael Marius Radkowski, Cary, NC (US); Chunbo Song, Arlington, VA (US); Angela Vivian Dcosta, Bangalore (IN)

(21) Appl. No.: 19/010,739

(22) Filed: Jan. 6, 2025

(51) Int. Cl. H04N 21/431; G09G 5/06; H04N 7/14; H04N 21/4788

(52) U.S. Cl. CPC H04N 21/4318; G09G 5/06; H04N 7/147; H04N 21/4788; G09G 2320/0666

(57) ABSTRACT

A system maintains stable image colors of a user, such as face tones, when the user is at a computer display device and the user's image is transmitted to other persons, such as in an online meeting. The system adjusts the user's image based on factors such as the light, color and brightness of the computer display device, foreground light and color, background light and color, and light incident on the user and background.

### TECHNICAL FIELD

Embodiments described herein relate to accounting for and addressing negative effects on a person's appearance in real-time camera situations caused by environmental lighting conditions such as from a computer display device, and in an embodiment, but not by way of limitation, probabilistically estimating true colors in the camera appearance of persons in real-time camera situations such as in video meetings.

### BACKGROUND

In video meetings using devices that include cameras capturing and displaying images of meeting participants, a meeting participant's appearance such as the skin tone and complexion and other foreground and background colors in the video may change depending on the emitted light and colors from the display and other foreground light sources. Also, a participant can change the desktop brightness and content, which also affects the participant's appearance due to changed emitted light strength and colors. The color and tone of the video background (background concealment image or actual captured background) affect the participant's appearance and the rendering of the participant in the video. For instance, the participant's skin tone may vary due to various display content and background. The ambient light in the environment can change, which also affects the user's appearance in the video image.

All these factors cause the appearance of the meeting participant (with respect to the background) to vary during a video conference call or other online meeting. Also, cameras used in such video meetings lack color-consistency, which is an undesired user experience.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a series of images illustrating how an appearance of a person in a video meeting can vary depending on foreground light, background light, ambient light and brightness of the computer display device.

FIG. 2 is a block diagram of a system for estimating color and appearance of a person in the camera image and modifying the color and appearance of the person in the camera image. The camera image may be used in an online video meeting.

FIG. 3 is a graphical representation of a Bayesian network or model.

FIGS. 4A, 4B and 4C are a block diagram illustrating features and operations of a system and method for estimating the appearance of a person in a video meeting and modifying the appearance of the person in the video meeting.

FIG. 5 is a series of images illustrating how in an embodiment an appearance of a person in a video meeting can be modified to account for the effects of background light, foreground light, and light from a computer display device.

FIG. 6 is a block diagram of a computer architecture upon which one or more of the embodiments disclosed herein can execute.

### DETAILED DESCRIPTION

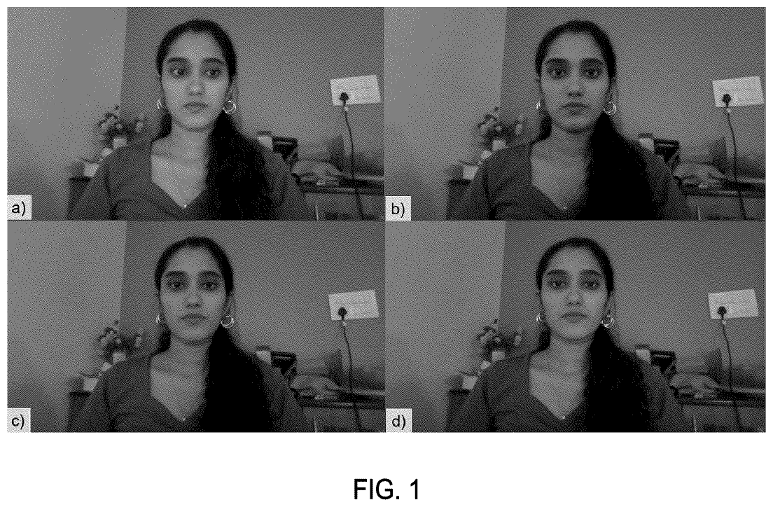

FIG. 1 is a series of images illustrating how an appearance of a person in a video meeting can vary depending on foreground light, background light, ambient light and brightness and content on the computer display device. An embodiment addresses these variances by maintaining stable image characteristics (brightness, contrast, color saturation, exposure, etc.) of physical features, e.g., face tones and/or complexions, which are independent of the desktop content (desktop windows colors, saturation, light versus dark mode, etc.) and brightness, and aligns with the general tone of the video background, the ambient light in the video and/or a background concealment image by predicting the impact other light sources have on a user's appearance in a video. The embodiment can predict the correct facial tone (or tone of other physical features) (with respect to a reference on the same display) of the user using the actual appearance in the video by “removing” the effect that front and display light (or brightness) and color have on the user's appearance. The embodiment considers the brightness and color, for instance, that the desktop emits, and removes the impact from the actual user appearance in the video, thereby contributing to yield the true face tone in conjunction with the room and user light/brightness and color observations.

In an embodiment, it is assumed that ambient light conditions exist that allow a camera that is being used in a video meeting to render an acceptable appropriate image of the user and background (no over- and/or under-saturation of the video, no strong point lights, etc.). It is further assumed in this embodiment that no other strong, direct light source illuminates a user's face.

An embodiment incorporates four primary components outlined as follows. First, the embodiment determines the emitted desktop color and brightness. The goal is to determine the level of impact the emitted screen brightness has on the user's appearance. The embodiment captures and analyzes screenshots for color and brightness distribution estimates across the screen and reads the screen brightness level (backlight strength). Second, the embodiment determines the current light and shading conditions on the user and in the room. The goal is to estimate the level of impact the room light has on the user's appearance (skin tone, hair, upper body, etc.). The embodiment captures and processes the camera image to determine the current brightness and color situation in the background and across the user. Third, the embodiment estimates the most probable appearance (e.g., the skin tone) of the user. The goal is to estimate the most probable appearance of the user, given the emitted desktop brightness and colors from the first step as well as the brightness and colors in the background and across the user from the second step. The embodiment uses a Bayesian model to determine the most probable (true) appearance by estimation, thus “subtracting” the impact brightness and color have on the user. In a probabilistic sense, the probable appearance is the Bayesian prior, learned during training from reference images. Fourth, the embodiment corrects the camera image to render the user's most probable appearance. Using the results from the third step, the embodiment computes a color correction map to alter the camera image of the user with the goal of maintaining a stable user appearance unaffected by any desktop color and brightness changes as well as ambient light and specular light changes. The color correction map is used to generate a diffuse image, and the camera image is split into specular and ambient image components. The embodiment uses a normal map, a specular image map, the ambient image map, the diffuse image map as input for a Phong Shader to re-render the new camera image. The result is a corrected, correctly shaded user.

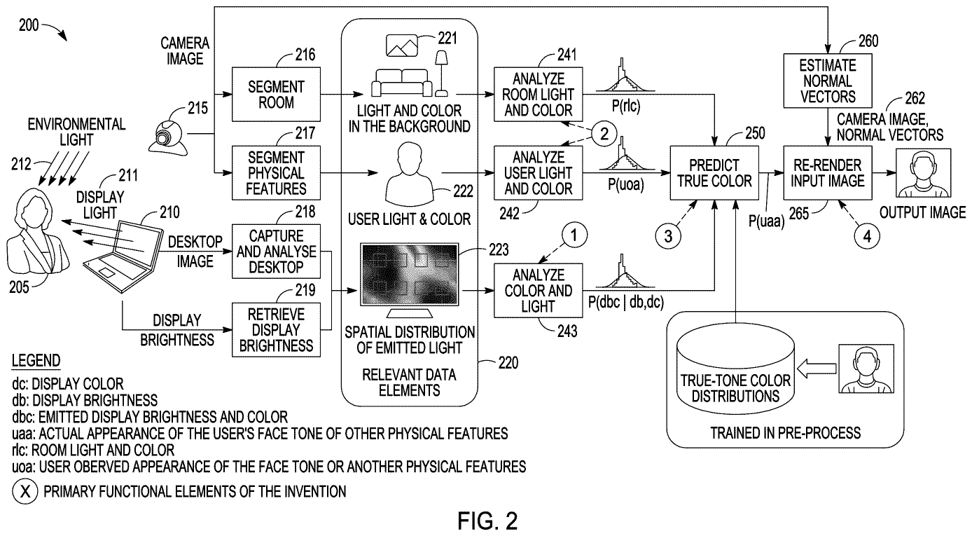

FIG. 2 is a block diagram of a system 200 for estimating color, complexion and appearance of a person in a video meeting and modifying the appearance of the person in the video meeting. A meeting participant or user 205 uses a computer display device 210 that includes a screen that emits light 211 onto the user 205. Also, environmental light 212 is emitted or incident on the user 205. A camera 215 captures an image of the user 205, and the image is segmented into room segments 216 and body regions (also referred to as physical features) 217 of the user 205. The camera 215 also captures and analyses the image at 218, and reads the brightness of the display at 219. In relevant data operations 220, the room segments 216 are analyzed for brightness and color in the background at 221, and the body regions 217 are also analyzed for brightness on the user 205 and color of the user 205 at 222. At 223, the operations 220 at 223 analyze the spatial distributions of the emitted light.

At 241, 242, and 243, room, user and display brightness and colors are analyzed to arrive at a predicted true color 250. Specifically, as disclosed in more detail below, at 241, a probability of the room brightness and color are determined. At 242, a probability of the user observed appearance of the face tone or other physical features is determined. And at 243, a probability of the emitted display brightness and color as a function of display brightness and color are determined. In determining the true predicted color, the system 200 uses a trained database of the true tone color distributions of a plurality of persons. The output of the predicted true color operation 250 is a probability of the actual appearance of the user's face tone or other physical features as re-rendered from the camera image 262 at 260 and a displayed re-rendered image at 265.

A Bayesian model describes the relations between the relevant stochastic parameters and allows the determination of the true color of a user's area-of-interest (aoi). Here, the term area-of-interest refers to individual “sections” of the user in a camera image such as the skin, the eyes, hair, and other features, also referred to as physical features. As an example, if a laptop emits red light, and the user appears red-shaded, the model can determine the probability that the user appearance is incorrect as well as the infer the correct skin tone and color. Note that this disclosure will use the skin tone as an example. However, the true tone can be determined for every identifiable physical feature of the user.

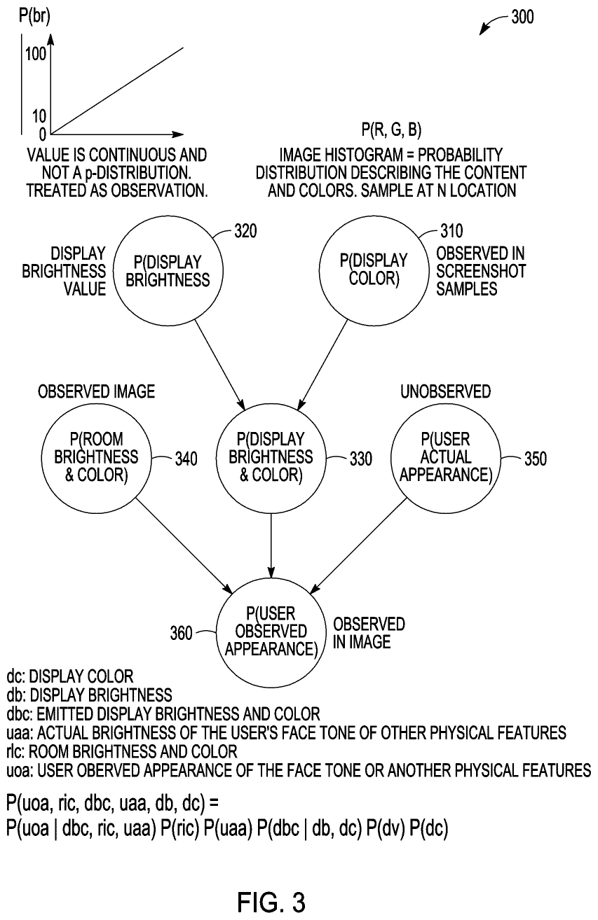

FIG. 3 is a graphical representation of a Bayesian network or model 300. The task of the Bayesian network is to describe the relationship between the observed user appearance, the room conditions, the desktop brightness and color, and the user's most probable color (e.g., skin tone P(uaa)). The phrase “most probable color” indicates the color/brightness-corrected image showing the user's appearance under white-light conditions and a dark display.

Referring now specifically to FIG. 3, the Bayesian model uses the following stochastic variables. The display color dc distribution and probability P(dc) 310 refer to and model the color that the display renders. They model the impact the display content has on the user. The desktop is observed using screenshots. The screenshots are sampled to generate color histograms per sample to determine the color distribution. The probability P(dc) describes the probability that the display color has been observed (treated as a random event) so that the Bayesian network can model the relation between the observation and other parameters, as explained in detail below.

The display brightness db and probability P(db) 320 refer to the probability that one observes a certain display brightness. The variable models the impact the screen brightness has on the user. Like P(dc), treating this value as a random event allows the use of the Bayesian model to describe the relationship between variables.

The observed display brightness and color dbc and probability P(dbc) 330 combine the display color dc 310 and display brightness db 320. The combination of the display brightness and content affect the user, and the variable describes the relation of color and brightness. This represents the emitted light and the impact on the user's face.

The room light and color rlc and probability P(rlc) 340 refer to the room brightness and color and are sampled from camera images showing either the actual user background or a background concealment image. The variable P(rlc) describes the prior probability that this room appearance has been observed. It describes the effect the ambient room light has on the user (e.g., if a room is dark or illuminated in red, the user appearance in a video will change).

The user actual appearance (uaa) and probability P(uaa) 350 refer to the actual and “correct” user appearance. As noted in FIG. 3, this variable is not observable since any user can only be observed in the presence of light. It is therefore arbitrarily defined in an embodiment as the user appearance of any physical feature, e.g., skin tone subjected to a Standard Illuminant D65.

The user observable appearance uoa and probability P(uoa) 360 represent the observable user appearances with the user subjected to ambient room light and display light and color. In other words, uoa and its observable values represent how one sees the user. The probability P(uoa) represents how likely a certain user appearance is.

Overall, the joint probability distribution for the Bayesian network is modeled as:

$$P ( uoa , rlc , uaa , dbc , db , dc ) = P ( uoa \vert dbc , rlc , uaa ) P ( rlc ) P ( uaa ) P ( dbc \vert db , dc ) P ( db ) P ( dc ) \qquad Eq . 1$$

In general, the Bayesian network allows a modeling of the relation between the variables, and the probability values of the variables describe how likely certain combinations appear. It permits a prediction of the most probable appearance of a user and a correction to render the most probable appearance of the user given the current camera input.

The entire problem of adjusting the image color is a multi-dimensional problem for any post-processor. This problem is simplified using segmentation and a splitting of the image. That is, the problem is divided into sub-problems by using one Bayesian network per segmented area; each segmented area may cover one physical feature. This reduces the number of dependencies and results in an embodiment that is more technically practical.

The following describes how the individual components of the Bayesian model of FIG. 3 are computed as a part of the overall process of FIG. 2. It is an inference process that uses the camera image and screenshot samples as the input, which generates a rendered image with a corrected user appearance as the output. In this embodiment, the training process for the Bayesian model uses the same methods as described in FIG. 3, except for the inference. Also for training, the training embodiment samples multiple images to generate the probability distributions in the first place where the inference process samples images to generate an output.

First, the emitted display color dc 310 and brightness db 320 are determined as follows, that is, estimate the display color distribution dc and as well as the display brightness db. From a Bayesian perspective, the step determines the observable variables. The process to compute the color distribution utilizes the steps as follows. A screenshot is captured from the desktop. Screenshots are captured in regular intervals (e.g., every 1 second). The screenshots are sampled at N locations. Each sample location is a pre-defined rectangular area.

For each sample location n, an RGB histogram is computed. The RGB histogram describes the distribution of combined RGB values. To compute the histogram, the gray-scale values per channel are binned. In an embodiment, each bin covers a range of r=10, although other r values could be used. The histogram is then normalized.

Next, the sample dci is computed by calculating the KL-divergence between the Q (RGB) sample histogram and a reference histogram P(RGB). The training of the reference histogram is discussed below.

$$dc = {D}_{KL} ( P ‖ Q ) {\sum }_{x ∈ RGB} P ( RGB ) log ( \frac{P ( RGB )}{Q ( RGB )} ) \qquad Eq . 2$$

For all samples i:
The joint probability distribution for all samples is determined as:

$$P ( dc ) = P ( {dc}_{0} , {dc}_{1} , … , {dc}_{S} ) / N \qquad Eq . 3$$

with dcᵢ, the sample values, and N, the number of samples to normalize the result. The outcome is N values dcᵢ, which represents the observation. The index i represents the spatial location of the sample. It is the expectations of all KL-divergence values. The values dc; align with a value in the Bayesian network to output the probability P(dc). This concludes the estimate of dci. To determine db, the display brightness value is readied directly using a Windows API and it is transformed as follows:

$$bc = \frac{display brightness + base}{max brightness + base} \qquad Eq . 4$$

In equation 4, the display brightness refers to the value that Windows (or other operating system) provides and the max brightness is the maximum brightness value. The base parameter is an empirically identified value. It accounts for a completely dark display. Even if the brightness is at 0, the display can still have a significant impact on the user's appearance, e.g., in dark rooms. Without this value, the joint distribution P(dbc) could fail to represent variable relations in dark situations well. It is noted that the distributions for P(dbc), P(dc), and P(db) are determined from sample data in a pre-process.

In determining the current light/shading condition on the user (uoa) and in the room (rlc), the objective is to determine the current conditions in the room (rlc) and the observable user appearance (uoa). These variables are also observable using the camera image. The process to determine user and room conditions is the same. The difference is the data being processed. The process functions as follows. Each camera image is segmented into the (aoi), such as the user and the background. The user can further be split into physical features such as the skin, eyes, hair, etc. In an embodiment, the scene segmentation uses a semantic segmentation neural network.

The image is sampled at N locations. Each sample is a rectangular area of size width x height. Samples are collected as follows. Each sample is randomly placed over the segmented image. Before the sample is used, it is tested to determine whether it covers the segmented area. The sample is rejected if it does not cover the segmented area. If the number of rejected samples is too high (e.g., >N*5, but 5 is an empirically selected value that may change), the width and height are reduced in size by a factor, such as by a factor of two. The process is repeated until N samples have been collected. In an embodiment, a start value for the width×height could be 64.

Then, for each sample location, an RGB histogram is computed. The RGB histogram describes the distribution of combined RGB values. To compute the histogram, the gray-scale values per channel are binned. In an embodiment, each bin covers a range of r=10, but in other embodiments other r values could be used. The histogram is then normalized. Next, equation no. 2 is used to compute the KL-divergence with respect to reference sample collected from the user in a pre-process. The perceivable brightness (pb) for the sample location is also estimated and it is used as another indicator for the user's appearance. All samples for the joint probability distribution uoa for this sample are as follows:

$$P ( {uao}_{i} ) = P ( {uao}_{0} , {uoa}_{1} , … , {uao}_{N} , pb ) \qquad Eq . 5$$

The complete distribution for P(uoa) is also pre-determined during a training process.

The embodiment next estimates the most probable appearance (e.g., skin tone) of the user, or in other words, determining the most probable appearance of an aoi. Using the skin tone as an example, the most probable skin tone is inferred by using the Bayesian model and inferring uaa by elimination.

$$P ( uaa ) = \begin{matrix}\frac{P ( {uoa}^{+} , {rlc}^{+} , {uaa}^{-} , {dbc}^{+} , {db}^{+} , {dc}^{+} )}{P ( {uoa}^{+} \vert {dbc}^{+} , {rlc}^{+} , {uaa}^{-} ) P ( {rlc}^{+} ) P ( {dbc}^{+} \vert {db}^{+} , {dc}^{+} ) P ( {db}^{+} ) P ( {dc}^{+} )}\end{matrix} \qquad Eq . 6$$

The process uses the measured evidence and infers the most probable user appearance from the joint distribution given the current conditions indicated by “+” in equation no. 6. The output is P(uaa), the probability value for each element of the distribution to be the true color, which is associated to an RGB color that describes the most probable color, or true color, for the selected aoi.

Lastly, the camera image is corrected to render the user's most probable appearance. The objective of this step is to correct the output image. The process re-renders the camera image using a Phong Shader using a normal map estimate, a disturbance map, and a color correction map, ambient map and specular map in the process.

The normal map Nis used to recover the shading of the image content during re-rendering. It is estimated from RGB colors using edge and shading gradients as the baseline to compute normal vectors from gradients. A seed point at a reference is used to initialize the first normal vector. All subsequent normal vectors are derived with respect to this seed point. Normal vectors generated using gradients are not 100% accurate and cannot be used for any calculations requiring accuracy. However, the delta between neighboring normal vectors is correct, which is sufficient to recover the shading of the image.

The disturbance map is used to maintain image details, artifacts, and all high-frequency disturbances in the image. In general, it allows the maintaining of image details. The disturbance map D is calculated as follows:

$$D = I - 𝒢 ( I ) \qquad Eq . 7$$

with I, the camera image, and G, a Gaussian Blur function. The output is a map with high-frequency details.

The color correction map C transfers the true colors uaaᵢ for each segmented portion into a pixel-wise diffuse image map. The segmentation maps are used and the class labels are replaced with the associated values uadᵢ.

In addition, a specular map S is used. The specular map S is extracted from the camera image I. The image is converted into YUV color space. The Y-channel contains specular components. The Y is normalized and the highlights (upper quarter of the histogram range) are used only as specular map S.

An ambient map A is used. The ambient map is extracted from the camera image. The image is converted into YUV color space. The ambient map is computed using the UV channels subtracted by the diffuse color correction map. The specular map S is subtracted from Y. The results Y′U′V′ represent the ambient light conditions per segmented area in an ambient image map.

The final user appearance is computed pixel-wise using a Phong Shader:

$${color}_{xy} = {C}_{xy} cos ( {N}_{xy} , L ) + {w}_{c} {C}_{xy} + {w}_{d} {D}_{xy} + \text{?} {S}_{xy} + w\_a \qquad Eq . 8$$

$$A\_xy$$

$$\text{?} \text{indicates text missing or illegible when filed}$$

Here, color_{xy} is the pixel-wise color output. The parameter C is the diffuse image map generated using the color correction map, N, the normal map, D, the disturbance map, A, the ambient map, and the specular map S (S and A are converted to RGB before being applied). All values are applied per the location x,y. The parameter w is a weight value. L is a constant light normal vector.

The first term of equation no. 8 is a diffuse Phong shader component. It reconstructs the diffuse appearance of the user. The other components add ambient light, details, and specular light.

The light vector is a given constant. It is assumed that light is coming from the front of the user and illuminates the user directly. Although this is an assumption that may not hold true in most of the cases, it will not negatively affect the image since no video conference observer will know all real positions of room lights. It is noted that the display brightness or room brightness is not modeled as Phong Shader light (light vector L) in equation no. 8. Both are already parameters of the color samples represented in the pre-trained Bayesian network and part of the color estimate inferred using equation no. 6.

When training the system, the goal is to establish the distribution of the Bayesian network for p(dc), p(db), p(dbc), p(uoa), p(uaa) and p(rlc). The network is trained from collected sample data and the training uses a sampling method to determine the distributions. In an embodiment, the training data are videos. One video shows various color patterns. For training, various color patterns are displayed on the desktop to illuminate the user and the related camera images are captured. A camera image associated with a black desktop functions as the reference image and it defines the acceptable color tones. When capturing data, the user is prompted to capture video data. At the same time, the desktop replays various color patterns illuminating the user with colors and color patterns. The video captured in bright light condition with a black desktop acts as the reference image. It is assumed that this image shows the user most accurately and the method aims to reproduce this color in an aoi, e.g., the face tone, when observing one of the other colors or color mixes. During training data collection, the user is asked to capture data at various room light conditions.

The Bayesian model works with discrete variables. One challenge is the number of samples required to obtain appropriate distributions. However, using a Bayesian model and treating the variables as random events allows the use of Bayesian model sampling techniques to interpolate variables values. The probability distributions are trained in the Bayesian network using a variant of Markov Chain Monte Carlo (MCMC) and Gibbs Sampling. It can sample from a conditional distribution and can cover for missing data. One problem with the Bayesian model is that it requires comprehensive distributions, covering all variables adequately. Although a variable set may be limited, this remains a challenging task and gaps in the data remain. The Gibbs method permits sampling assuming conditional dependencies. In other words, it permits the interpolation of a distribution from the dataset if some datapoints are missing. It is noted that the distribution should be estimated for each aoi. For instance, the skin tone of the user is represented in a different network than, e.g., the upper body.

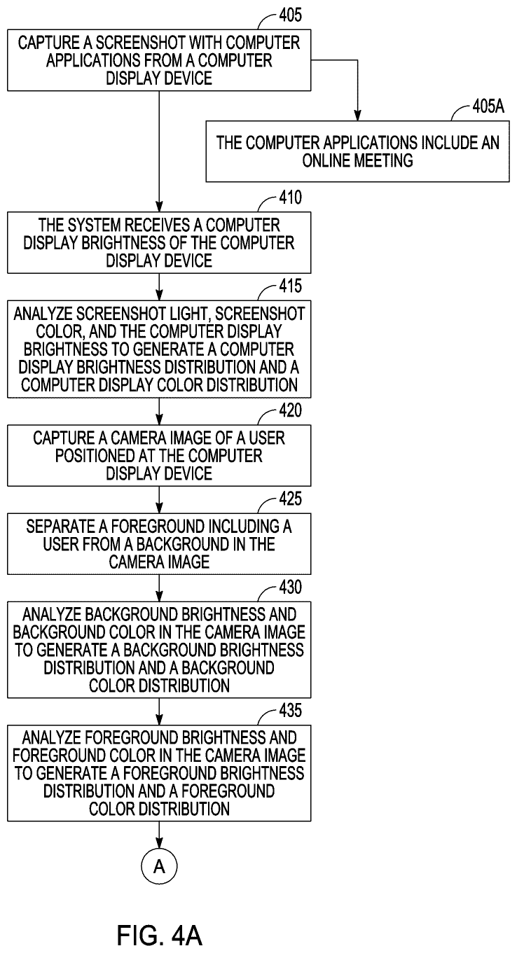

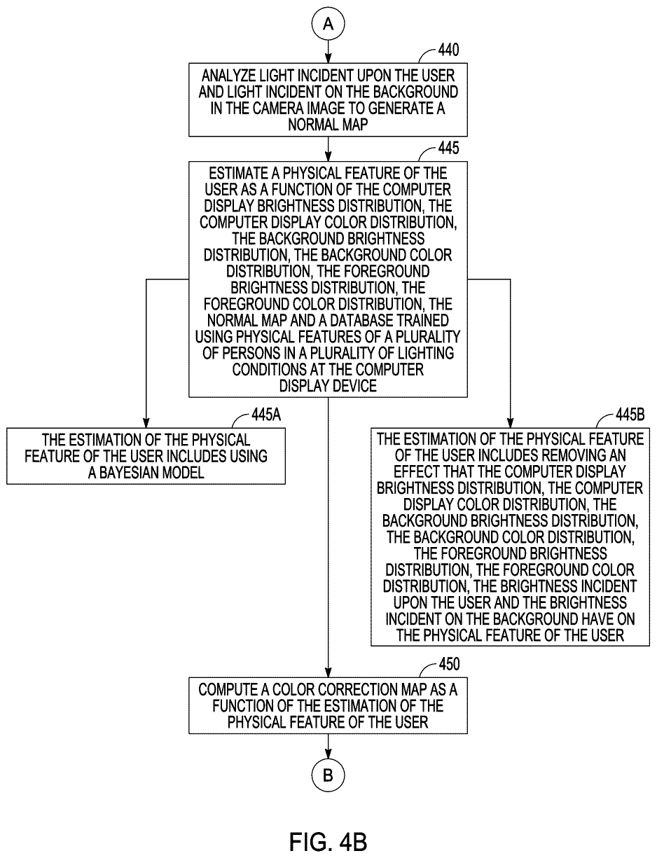

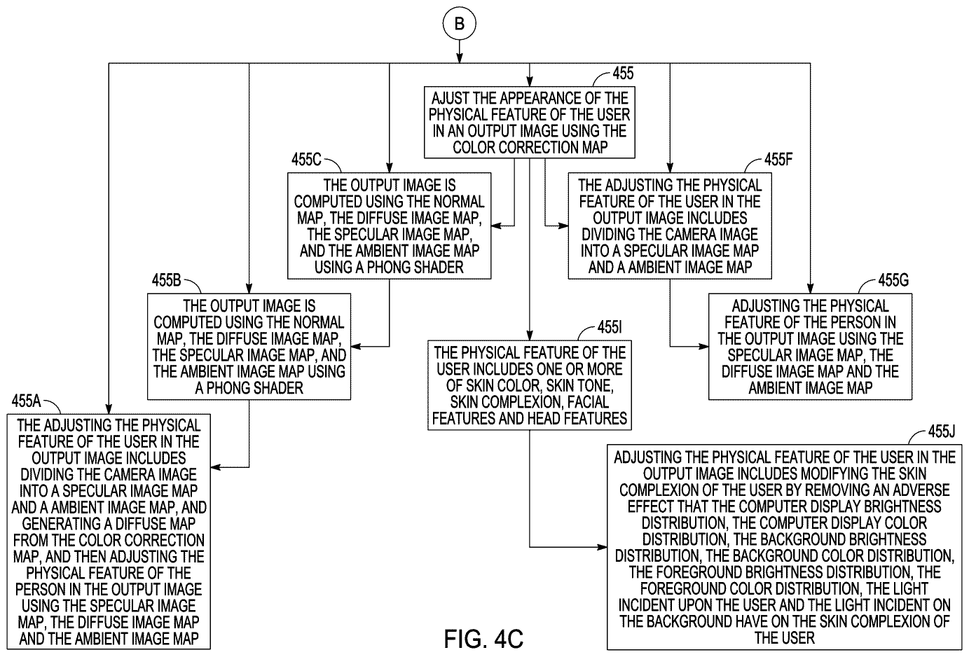

FIGS. 4A, 4B and 4C are a block diagram illustrating operations and features of a system for probabilistically estimating true colors in the appearance of persons in real-time camera situations such as in video meetings. FIGS. 4A, 4B and 4C include a number of process and feature blocks 405-455J. Though arranged substantially serially in the example of FIGS. 4A, 4B and 4C, other examples may reorder the blocks, omit one or more blocks, and/or execute two or more blocks in parallel using multiple processors or a single processor organized as two or more virtual machines or sub-processors.

Referring now to FIGS. 4A, 4B and 4C, at 405, a screenshot is captured from a computer display device. The screenshot can include one or more computer applications. As indicated at 405A, the one or more computer applications comprise a video meeting and the user is a participant in the video meeting.

At 410, the system receives a computer display brightness of the computer display device. At 415, screenshot light, screenshot color, and the computer display brightness are analyzed to generate a computer display brightness distribution and a computer display color distribution. At 420, a camera image of a user positioned at the computer display device is captured. At 425, a foreground including the user is separated from a background in the camera image. At 430, background brightness and background color in the camera image are analyzed to generate a background brightness distribution and a background color distribution. At 435, foreground brightness and foreground color in the camera image are analyzed to generate a foreground brightness distribution and a foreground color distribution. At 440, light incident upon the user and light incident on the background in the camera image are analyzed to generate a normal map.

At 445, an appearance of the physical feature of the user is estimated as a function of the computer display brightness distribution, the computer display color distribution, the background brightness distribution, the background color distribution, the foreground brightness distribution, the foreground color distribution, the normal map and a database trained using a plurality of appearances of physical features of a plurality of persons in a plurality of lighting conditions at the computer display device. As indicated at 445A, the estimation of the physical feature of the user includes using a Bayesian model. At 445B, the estimation of the physical feature of the user includes removing an effect that the computer display brightness distribution, the computer display color distribution, the background brightness distribution, the background color distribution, the foreground brightness distribution, the foreground color distribution, the light incident upon the user and the light incident on the background have on the physical feature of the user.

At 450, a color correction map is computed as a function of the estimation of the physical feature of the user.

Finally, at 455, the physical feature of the user is adjusted in an output image using the Phong shader with the color correction map as the input. At 455A, the adjusting the appearance of the physical feature of the user in the output image includes dividing the camera image into a specular image map and an ambient image map, and generating a diffuse image map from the color correction map, and then adjusting the appearance of the physical feature of the person in the output image using the specular image map, the ambient image map, the diffuse image map. As indicated at 455B, the output image is computed using the normal map, the diffuse image map obtained from the color correction map, and the specular image map, and the disturbance map using a Phong shader. At 455C, the output image is computed using the normal map, the diffuse image map, the specular image map, the ambient image map and the disturbance map using a Phong shader. Additionally, as indicated at 455F, the adjusting the physical feature of the user in the output image includes dividing the camera image into a specular image map and an ambient map and generating a diffuse map from the color correction map, and at 455G, adjusting the appearance of the physical feature of the person in the output image using the specular image map, an ambient map, and the diffuse image map, and the disturbance map.

As further indicated at 455I, the physical feature of the user can include one or more of skin color, skin tone, skin complexion, facial features and head features. And as indicated at 455J, adjusting the appearance of the physical feature of the user in the output image can include modifying the skin complexion of the user by removing an adverse effect that the computer display brightness distribution, the computer display color distribution, the background brightness distribution, the background color distribution, the foreground brightness distribution, the foreground color distribution, the light incident upon the user and the light incident on the background have on the skin complexion of the user.

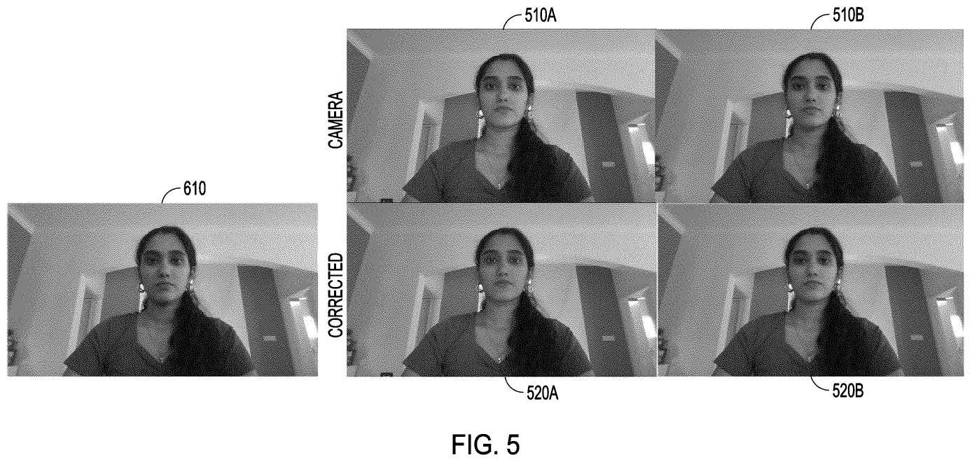

FIG. 5 illustrates an adjusted output image. Image 510 is a reference image, that is, an image of a user in which there are no adverse effects of foreground brightness, background brightness, and/or brightness and color from a computer display device. Images 510A and 510B are images captured by a camera, such as a camera on a laptop computer. Images 520A and 520B are the adjusted images, which strive to be very much like the reference image 510.

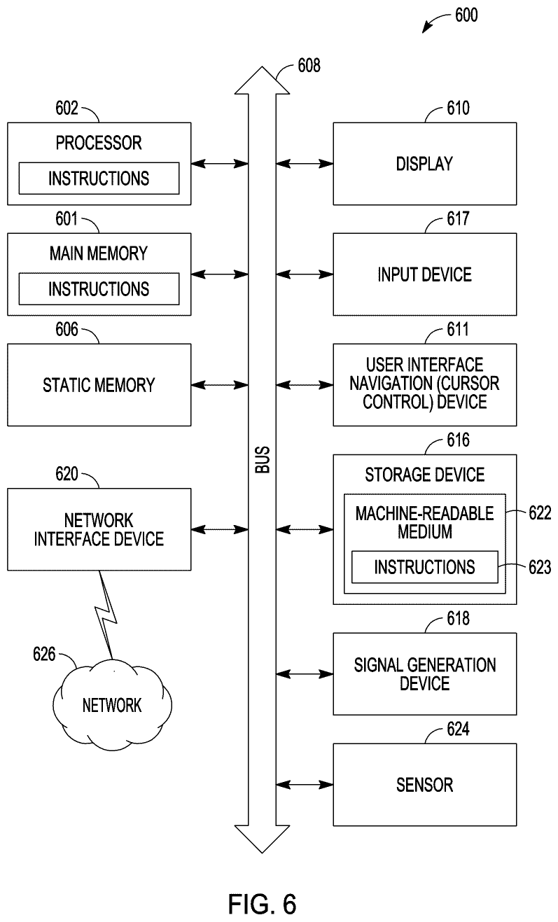

FIG. 6 is a block diagram illustrating a computing and communications platform 600 in the example form of a general-purpose machine on which some or all the operations of FIGS. 4A, 4B and 4C may be carried out according to various embodiments. In certain embodiments, programming of the computing platform 600 according to one or more particular algorithms produces a special-purpose machine upon execution of that programming. In a networked deployment, the computing platform 600 may operate in the capacity of either a server or a client machine in server-client network environments, or it may act as a peer machine in peer-to-peer (or distributed) network environments.

Example computing platform 600 includes at least one processor 602 (e.g., a central processing unit (CPU), a graphics processing unit (GPU) or both, processor cores, compute nodes, etc.), a main memory 601 and a static memory 606, which communicate with each other via a link 608 (e.g., bus). The computing platform 600 may further include a video display unit 610, input devices 617 (e.g., a keyboard, camera, microphone), and a user interface (UI) navigation device 611 (e.g., mouse, touchscreen). The computing platform 600 may additionally include a storage device 616 (e.g., a drive unit), a signal generation device 618 (e.g., a speaker), a sensor 624, and a network interface device 620 coupled to a network 626.

The storage device 616 includes a non-transitory machine-readable medium 622 on which is stored one or more sets of data structures and instructions 623 (e.g., software) embodying or utilized by any one or more of the methodologies or functions described herein. The instructions 623 may also reside, completely or at least partially, within the main memory 601, static memory 606, and/or within the processor 602 during execution thereof by the computing platform 600, with the main memory 601, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 623. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example No. 1 is a process comprising capturing a screenshot from a computer display device, the screenshot comprising one or more computer applications; receiving a computer display brightness of the computer display device; analyzing screenshot light, screenshot color, and the computer display brightness to generate a computer display brightness distribution and a computer display color distribution; capturing a camera image of a user positioned at the computer display device; separating a foreground including the user from a background in the camera image; analyzing background brightness and background color in the camera image to generate a background brightness distribution and a background color distribution; analyzing foreground brightness and foreground color in the camera image to generate a foreground brightness distribution and a foreground color distribution; analyzing light incident upon the user and light incident on the background in the camera image to generate a normal map; estimating a the appearance of a physical feature of the user as a function of the computer display brightness distribution, the computer display color distribution, the background brightness distribution, the background color distribution, the foreground brightness distribution, the foreground color distribution, the normal map and a database trained using physical features of a plurality of persons in a plurality of lighting conditions at the computer display device; computing a color correction map as a function of the estimation of the physical feature of the user; and adjusting the physical feature of the user in an output image using the color correction map.

Example No. 2 includes all the features of Example No. 1, and further optionally includes a process wherein the estimation of the true appearance of a physical feature of the user comprises using a Bayesian model to build a color correction map.

Example No. 3 includes all the features of Example Nos. 1-2, and further optionally includes a process wherein the adjusting the appearance of a physical feature of the user in the output image comprises dividing the camera image into a specular image map and ambient image map, and generating a diffuse image map from the color correction map, and adjusting the physical feature of the person in the output image using the specular image map, the diffuse image map and the ambient map.

Example No. 4 includes all the features of Example Nos. 1-3, and further optionally includes a process wherein the output image is computed using the normal map, the diffuse image map, the specular image map, and the ambient image map using a Phong shader.

Example No. 5 includes all the features of Example Nos. 1-4, and further optionally includes a process wherein the one or more computer applications comprise an video meeting and the user is a participant in the video meeting.

Example No. 6 includes all the features of Example Nos. 1-5, and further optionally includes a process wherein the estimating true appearance of the physical feature of the user comprises removing an effect that the computer display brightness distribution, the computer display color distribution, the background brightness distribution, the background color distribution, the foreground brightness distribution, the foreground color distribution, the light incident upon the user and the light incident on the background have on the physical feature of the user.

Example No. 7 includes all the features of Example Nos. 1-6, and further optionally includes a process wherein the physical feature comprises one or more of skin color, skin tone, skin complexion, facial features and head features.

Example No. 8 includes all the features of Example Nos. 1-7, and further optionally includes a process wherein adjusting the appearance of a physical feature of the user in the output image comprises modifying the skin complexion of the user by removing an adverse effect that the computer display brightness distribution, the computer display color distribution, the background brightness distribution, the background color distribution, the foreground brightness distribution, the foreground color distribution, the light incident upon the user and the light incident on the background have on the skin complexion of the user.

Example No. 9 is a non-transitory machine-readable medium comprising instructions that when executed by a processor execute a process comprising capturing a screenshot from a computer display device, the screenshot comprising one or more computer applications; receiving a computer display brightness of the computer display device; analyzing screenshot light, screenshot color, and the computer display brightness to generate a computer display brightness distribution and a computer display color distribution; capturing a camera image of a user positioned at the computer display device; separating a foreground including the user from a background in the camera image; analyzing background brightness and background color in the camera image to generate a background brightness distribution and a background color distribution; analyzing foreground brightness and foreground color in the camera image to generate a foreground brightness distribution and a foreground color distribution; analyzing light incident upon the user and light incident on the background in the camera image to generate a normal map; estimating the appearance of a physical feature of the user as a function of the computer display brightness distribution, the computer display color distribution, the background brightness distribution, the background color distribution, the foreground brightness distribution, the foreground color distribution, the normal map and a database trained using physical features of a plurality of persons in a plurality of lighting conditions at the computer display device; computing a color correction map as a function of the estimation of the physical feature of the user using a Bayesian network; and adjusting the physical feature of the user in an output image using a Phong shader with a ambient image map, a specular image map, and a diffuse image map, where the diffuse map is generated from the color correction map.

Example No. 10 includes all the features of Example No. 9, and further optionally includes a non-transitory machine-readable medium wherein the estimation of the physical feature of the user comprises using a Bayesian model.

Example No. 11 includes all the features of Example Nos. 9-10, and further optionally includes a non-transitory machine-readable medium wherein the adjusting the physical feature of the user in the output image comprises dividing the camera image into a specular image map and an ambient image map, and generating a diffuse map from the color correction map, and adjusting the physical feature of the person in the output image using the specular image map, the diffuse image map and the ambient imagemap.

Example No. 12 includes all the features of Example Nos. 9-11, and further optionally includes a non-transitory machine-readable medium wherein the output image is computed using the normal map, the diffuse image map, the specular image map, and the ambient image map using a Phong shader.

Example No. 13 includes all the features of Example Nos. 9-13, and further optionally includes a non-transitory machine-readable medium wherein the one or more computer applications comprise an video meeting and the user is a participant in the video meeting.

Example No. 14 includes all the features of Example Nos. 9-13, and further optionally includes a non-transitory machine-readable medium wherein the estimating the physical feature of the user comprises removing an effect that the computer display brightness distribution, the computer display color distribution, the background brightness distribution, the background color distribution, the foreground brightness distribution, the foreground color distribution, the light incident upon the user and the light incident on the background have on the physical feature of the user.

Example No. 15 includes all the features of Example Nos. 9-14, and further optionally includes a non-transitory machine-readable medium wherein the physical feature comprises one or more of skin color, skin tone, skin complexion, facial features and head features.

Example No. 16 includes all the features of Example Nos. 9-15, and further optionally includes a non-transitory machine-readable medium wherein adjusting the physical feature of the user in the output image comprises modifying the skin complexion of the user by removing an adverse effect that the computer display brightness distribution, the computer display color distribution, the background brightness distribution, the background color distribution, the foreground brightness distribution, the foreground color distribution, the light incident upon the user and the light incident on the background have on the skin complexion of the user.

Example No. 17 is a system comprising a computer processor; and a memory coupled to the computer processor; wherein the computer processor and the memory are operable for capturing a screenshot from a computer display device, the screenshot comprising one or more computer applications; receiving a computer display brightness of the computer display device; analyzing screenshot light, screenshot color, and the computer display brightness to generate a computer display light distribution and a computer display color distribution; capturing a camera image of a user positioned at the computer display device; separating a foreground including the user from a background in the camera image; analyzing background brightness and background color in the camera image to generate a background brightness distribution and a background color distribution; analyzing foreground brightness and foreground color in the camera image to generate a foreground brightness distribution and a foreground color distribution; analyzing light incident upon the user and light incident on the background in the camera image to generate a normal map; estimating the appearance of a physical feature of the user as a function of the computer display brightness distribution, the computer display color distribution, the background brightness distribution, the background color distribution, the foreground brightness distribution, the foreground color distribution, the normal map and a database trained using physical features of a plurality of persons in a plurality of lighting conditions at the computer display device; computing a color correction map as a function of the estimation of the appearance of physical feature of the user; and adjusting the appearance of physical feature of the user in an output image using the color correction map.

Example No. 18 includes all the features of Example No. 17, and further optionally includes a system wherein the adjusting the physical feature of the user in the output image comprises dividing the camera image into a specular image map and an ambient image map, and adjusting the physical feature of the person in the output image using the specular image map, the diffuse image map and the ambient image map; and generating a diffuse image map from the color correction map; and wherein the output image is computed using the normal map, the diffuse image map, the specular image map, and the ambient image map using a Phong shader.

Example No. 19 includes all the features of Example Nos. 17-18, and further optionally includes a system wherein the estimating the physical feature of the user comprises removing an effect that the computer display brightness distribution, the computer display color distribution, the background brightness distribution, the background color distribution, the foreground brightness distribution the foreground color distribution, the light incident upon the user and the light incident on the background have on the physical feature of the user.

Example No. 20 includes all the features of Example Nos. 17-19, and further optionally includes a system wherein the physical feature comprises one or more of skin color, skin tone, skin complexion, facial features and head features; and wherein adjusting the physical feature of the user in the output image comprises modifying the skin complexion of the user by removing an adverse effect that the computer display brightness distribution, the computer display color distribution, the background brightness distribution, the background color distribution, the foreground brightness distribution, the foreground color distribution, the light incident upon the user and the light incident on the background have on the skin complexion of the user.

1. A process comprising:
capturing a screenshot from a computer display device, the screenshot comprising one or more computer applications;
receiving a computer display brightness of the computer display device;
analyzing screenshot light, screenshot color, and the computer display brightness to generate a computer display brightness distribution and a computer display color distribution;
capturing a camera image of a user positioned at the computer display device;
separating a foreground including the user from a background in the camera image;
analyzing background brightness and background color in the camera image to generate a background brightness distribution and a background color distribution;
analyzing foreground brightness and foreground color in the camera image to generate a foreground brightness distribution and a foreground color distribution;
analyzing light incident upon the user and light incident on the background in the camera image to generate a normal map;
estimating an appearance of a physical feature of the user as a function of the computer display brightness distribution, the computer display color distribution, the background brightness distribution, the background color distribution, the foreground brightness distribution, the foreground color distribution, the normal map and a database trained using physical features of a plurality of persons in a plurality of lighting conditions at the computer display device;
computing a color correction map as a function of the estimation of the physical feature of the user; and
adjusting an appearance of the physical feature of the user in an output image using the color correction map.

2. The process of claim 1, wherein the estimation of the physical feature of the user comprises using a Bayesian model.

3. The process of claim 1, wherein the adjusting the physical feature of the user in the output image comprises dividing the camera image into a specular image map and a ambient image map, and generating a diffuse map out of the color correction map, and adjusting the physical feature of the person in the output image using the specular image map, the diffuse image map and the ambient map.

4. The process of claim 3, wherein the output image is computed using the normal map, the diffuse image map, the specular image map, and ambient image map using a Phong shader.

5. The process of claim 1, wherein the one or more computer applications comprise an video meeting and the user is a participant in the video meeting.

6. The process of claim 1, wherein the estimating the physical feature of the user comprises removing an effect that the computer display brightness distribution, the computer display color distribution, the background brightness distribution, the background color distribution, the foreground brightness distribution, the foreground color distribution, the light incident upon the user and the light incident on the background have on the physical feature of the user.

7. The process of claim 1, wherein the physical feature comprises one or more of skin color, skin tone, skin complexion, facial features and head features.

8. The process of claim 7, wherein adjusting the physical feature of the user in the output image comprises modifying the skin complexion of the user by removing an adverse effect that the computer display brightness distribution, the computer display color distribution, the background brightness distribution, the background color distribution, the foreground brightness distribution, the foreground color distribution, the light incident upon the user and the light incident on the background have on the skin complexion of the user.

9. A non-transitory machine-readable medium comprising instructions that when executed by a processor execute a process comprising:
capturing a screenshot from a computer display device, the screenshot comprising one or more computer applications;
receiving a computer display brightness of the computer display device;
analyzing screenshot light, screenshot color, and the computer display brightness to generate a computer display brightness distribution and a computer display color distribution;
capturing a camera image of a user positioned at the computer display device;
separating a foreground including the user from a background in the camera image;
analyzing background brightness and background color in the camera image to generate a background brightness distribution and a background color distribution;
analyzing foreground brightness and foreground color in the camera image to generate a foreground brightness distribution and a foreground color distribution;
analyzing light incident upon the user and light incident on the background in the camera image to generate a normal map;
estimating an appearance of a physical feature of the user as a function of the computer display brightness distribution, the computer display color distribution, the background brightness distribution, the background color distribution, the foreground brightness distribution, the foreground color distribution, the normal map and a database trained using physical features of a plurality of persons in a plurality of lighting conditions at the computer display device;
computing a color correction map as a function of the estimation of the physical feature of the user; and
adjusting an appearance of the physical feature of the user in an output image using the color correction map.

10. The non-transitory machine-readable medium of claim 9, wherein the estimation of the physical feature of the user comprises using a Bayesian model.

11. The non-transitory machine-readable medium of claim 9, wherein the adjusting the physical feature of the user in the output image comprises dividing the camera image into a specular image map and an ambient image map, and generating a diffuse image map from the color correction map, and adjusting the physical feature of the person in the output image using the specular image map, the diffuse image map and the color correction map.

12. The non-transitory machine-readable medium of claim 11, wherein the output image is computed using the normal map, the diffuse image map, the specular image map, and the ambient image map using a Phong shader.

13. The non-transitory machine-readable medium of claim 9, wherein the one or more computer applications comprise an online meeting and the user is a participant in the online meeting.

14. The non-transitory machine-readable medium of claim 9, wherein the estimating the physical feature of the user comprises removing an effect that the computer display brightness distribution, the computer display color distribution, the background brightness distribution, the background color distribution, the foreground brightness distribution, the foreground color distribution, the light incident upon the user and the light incident on the background have on the physical feature of the user.

15. The non-transitory machine-readable medium of claim 9, wherein the physical feature comprises one or more of skin color, skin tone, skin complexion, facial features and head features.

16. The non-transitory machine-readable medium of claim 15, wherein adjusting the physical feature of the user in the output image comprises modifying the skin complexion of the user by removing an adverse effect that the computer display brightness distribution, the computer display color distribution, the background brightness distribution, the background color distribution, the foreground brightness distribution, the foreground color distribution, the light incident upon the user and the light incident on the background have on the skin complexion of the user.

17. A system comprising:
a computer processor;
a memory coupled to the computer processor;
wherein the computer processor and the memory are operable for:
capturing a screenshot from a computer display device, the screenshot comprising one or more computer applications;
receiving a computer display brightness of the computer display device;
analyzing screenshot light, screenshot color, and the computer display brightness to generate a computer display brightness distribution and a computer display color distribution;
capturing a camera image of a user positioned at the computer display device;
separating a foreground including the user from a background in the camera image;
analyzing background brightness and background color in the camera image to generate a background brightness distribution and a background color distribution;
analyzing foreground brightness and foreground color in the camera image to generate a foreground brightness distribution and a foreground color distribution;
analyzing light incident upon the user and light incident on the background in the camera image to generate a normal map;
estimating a physical feature of the user as a function of the computer display brightness distribution, the computer display color distribution, the background brightness distribution, the background color distribution, the foreground brightness distribution, the foreground color distribution, the normal map and a database trained using physical features of a plurality of persons in a plurality of lighting conditions at the computer display device;
computing a color correction map as a function of the estimation of the physical feature of the user; and
adjusting an appearance of the physical feature of the user in an output image using the color correction map.

18. The system of claim 17, wherein the adjusting the physical feature of the user in the output image comprises dividing the camera image into a specular image map and an ambient image map, and generating a diffuse image map from the color correction map, and adjusting the physical feature of the person in the output image using the specular image map, the diffuse image map and the ambient image map; and wherein the output image is computed using the normal map, the diffuse image map, the specular image map, and the ambient image map using a Phong shader.

19. The system of claim 17, wherein the estimating the physical feature of the user comprises removing an effect that the computer display brightness distribution, the computer display color distribution, the background brightness distribution, the background color distribution, the foreground brightness distribution, the foreground color distribution, the light incident upon the user and the light incident on the background have on the physical feature of the user.

20. The system of claim 17, wherein the physical feature comprises one or more of skin color, skin tone, skin complexion, facial features and head features; and wherein adjusting the physical feature of the user in the output image comprises modifying the skin complexion of the user by removing an adverse effect that the computer display brightness distribution, the computer display color distribution, the background brightness distribution, the background color distribution, the foreground brightness distribution, the foreground color distribution, the light incident upon the user and the light incident on the background have on the skin complexion of the user.
